(19) United States
(12) Patent Application Publication
(10) Pub. No.: US 2003/0120733 A1
(43) Pub. Date: Jun. 26, 2003

(54) Email system that allows sender to check recipient's status before sending an email to the recipient

(76) Inventor: George H. Forman, SE Port Orchard, WA (US)

Correspondence Address: HEWLETT-PACKARD COMPANY, Intellectual Property Administration, P.O. Box 272400, Fort Collins, CO, 80527-2400, US

(21) Appl. No.: 10/027,704

(22) Filed: Dec. 21, 2001

(51) Int. Cl. G06F 15/16

(52) U.S. Cl. 709/206

(57) ABSTRACT

An email system includes a server and client applications operatively coupled to the server. Each application operates on behalf of a given email address and the server forwards messages among the applications based on email addresses specified for the messages. When a recipient application that assumes a recipient email address has a status change in its message receiving and handling mode, that change is communicated from the recipient application to the server and is recorded in a status table indexed under email addresses. When the user of another application (i.e., sender application) wants to send a message to the recipient email address and has specified the recipient email address, the sender application queries the table in the server for the current status of the recipient email address by sending an inquiry to the table with the recipient email address so that the status of the recipient email address is determined before a message is sent to the recipient email address.

### BACKGROUND OF THE INVENTION

1. Field of the Invention

The present invention pertains to email services. More particularly, this invention relates to an email system that allows an email client application (i.e., sender) to check status of another email client application (i.e., recipient) before sending an email to the recipient such that time and effort will not be spent on messages that will not be timely attended to by the intended recipient.

2. Description of the Related Art

A simple electronic mail (hereinafter email) system typically includes an email server operatively connected to a number of email client applications. A more realistic implementation is that the email system includes a number of similar or different email servers connected together via a network. Each of the email servers is also operatively connected to a number of email client applications.

In either case, the email server is typically implemented by email server software running on a computer system. The computer system can be a server computer, a workstation computer, a mainframe computer, or a super-computer. The computer system may also be a number of computers connected together via a network. The email server software can be the Microsoft Exchange® email server software manufactured and sold by Microsoft Corporation of Redmond, Wash.

Each email client application is typically implemented by software running on a user terminal or client device. The user terminal can be a personal computer system, or a non-traditional-computer digital device, such as a personal digital assistant, a pager, a cellular phone. The email client application can be implemented in a variety of ways. One example of the email client application is the Microsoft Outlook® email client application software manufactured and sold by Microsoft Corporation of Redmond, Wash. Another example of the email client application can be the Netscape Communicator® (or Netscape 6) client manufactured and made available by AOL-Time Warner, Inc. of New York, N.Y. The Netscape Communicator® is a comprehensive set of components that integrates browsing, email, and chat functions together to allow users to easily communicate, share, and access information. A further example of the email client application can be the AOL® 6.0 or 7.0 interactive service software (which includes the email function) also manufactured and made available by AOL-Time Warner, Inc. of New York, N.Y.

Each user terminal is connected to its corresponding email server computer (i.e., the computer system that runs the email server software) via a communication network. The email servers and the client applications communicate with each other following a client-server model and rely on the Transmission Control Protocol (TCP) for reliable delivery of information or applications between servers and client applications.

Each user of an email client application is assigned with an email address. When a user of a particular email address logs into an email system through an email client application, the email client application assumes the email address of the logged-in user. The email client application then communicates with its corresponding email server to receive all email messages sent to that particular email address. The user can also send email messages to other email addresses via the email client application.

Some of the prior art email client applications may also include additional functions. For example, the Microsoft Outlook® email client application provides an Out-Of-Office Assistant function to its user. The Out-Of-Office Assistant function, when set for an email address, automatically sends a pre-composed reply message to any message sent to that email address. Thus, this function is an auto-reply function that allows a sender of an email message to immediately know that the intended recipient will not read the message in a timely way.

Nonetheless, the prior art email system bears disadvantages. One disadvantage is that time and effort are often wasted when a sender composes and sends a message to a recipient who is away from their email for an extended period, even though they may have set the auto-reply or vacation notification function on. Here, the sender only learns that the recipient is on leave or on vacation after the message is sent and the auto-reply comes back. As we know, many email messages are time specific and some even require immediate reply. It is sometimes a waste of time and effort on the returned recipient to read messages that no longer require the recipient's attention.

Another disadvantage is that the sender cannot check the status of a recipient before sending the message to the recipient. The sender can only learn the status of the recipient after sending a message to the recipient. In many situations, however, a sender may not want to send messages to a recipient had the sender known that the recipient was on leave or on vacation and would not read the message until after the recipient is back.

### SUMMARY OF THE INVENTION

One feature of the present invention is to provide an email system that allows users of the system to save time and effort.

Another feature of the present invention is to provide an email system that allows users of the system not to spend time and effort to compose a message that will be sent to an invalid email address or to an email application that has its auto-reply function set.

Another feature of the present invention is to provide an email system that checks status of a receiving email address before sending an email to the receiving application.

In accordance with one embodiment of the present invention, an email system is described that includes a server and client applications operatively coupled to the server. Each client application has an email address and the server forwards messages among the applications based on email addresses specified for the messages. When a recipient application has a status change in its message receiving and handling mode, that change is communicated from the recipient application to the server and is recorded in a status table that is searchable using email addresses. When the user of another application (i.e., sender application) wants to send a message to the recipient's email address and has specified the email address of the recipient application, the sender application queries the table in the server for the current status of the recipient application by sending an inquiry to the table with the email address of the recipient application such that the status of the recipient application is determined before a message is sent to the recipient application. If the recipient has enabled created an auto-reply message, the message can be displayed by the sender application to forewarn the user of the sender application.

This checking process is done quickly as soon as the recipient email address is known. This allows the status information to be displayed before the user of the sender application gets very far in their typing.

In accordance with another embodiment of the present invention, an email system is described that includes a sender email server operatively coupled to at least a sender email client application and a recipient email server operatively coupled to at least a recipient email client application. Each application has a unique email address and the servers forward messages among each other and the applications based on email addresses specified for the messages. When the recipient application has a status change in message receiving and handling mode, that change is communicated from the recipient application to the recipient server and is recorded in a status table indexed under email addresses. The table only stores status information of each of the client applications coupled to the recipient email server. When the user of the sender application wants to send a message to the recipient application and has specified the email address of the recipient application, the sender application sends an inquiry with the email address of the recipient application to the sender server which in turn forwards the inquiry to the recipient server (after determining that the recipient email address belongs to the recipient server). The recipient server queries its table for the current status of the recipient application, and sends back the status information to the sender server. The sender server passes the status information of the recipient application to the sender application such that the status of the recipient application is determined before the message is sent to the recipient application.

Other features and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates an email system that implements one embodiment of the present invention, wherein the email system includes an email server system and a number of client systems with their email client applications.

FIG. 2 shows the structure of one of the email client applications of FIG. 1 that implements one embodiment of the present invention, wherein the email client application includes an application engine, a status change notification module, and a status check module.

FIG. 3 shows the status change notification process performed by the status change notification module of FIG. 2.

FIG. 4 shows the status check process performed by the status check module of FIG. 2.

FIG. 5 shows the structure of the email server system of FIG. 1 that implements one embodiment of the present invention, wherein the server system includes a server engine, a status table, and a status notification module.

FIG. 6 shows the status notification process performed by the status notification module of FIG. 5.

FIG. 7 illustrates an email system that implements another embodiment of the present invention, wherein the email system includes a number of email servers that communicate messages among one another and also to a number of client applications.

FIG. 8 shows the structure of one of the email servers of FIG. 7 that implements one embodiment of the present invention, wherein the server includes a server engine, a status table, and a status notification module.

FIG. 9 shows the status notification process performed by the status notification module of FIG. 8.

### DETAILED DESCRIPTION OF THE INVENTION

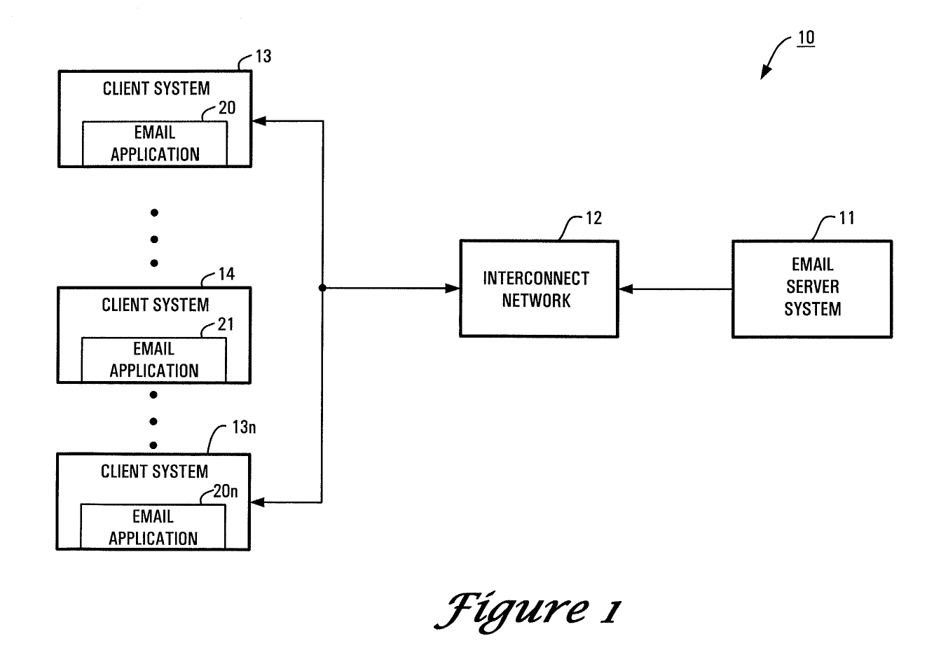

FIG. 1 shows an email system 10 that implements one embodiment of the present invention. Hereinafter, the term email refers to various kinds of electronic mail. For example, the email can be a text email, a voice email, or a video email.

As will be described in more detail below, the email system 10 allows a user of the system to check status of an email address before sending email messages to that email address. The status can be “normal”, “out-of-office”, or “invalid email address”. This means that the sender does not need to send any message to an email address in order to learn the status of that email address. This also avoids the situation in which a user spends time and effort to compose a message to a recipient, only to find that the recipient's email address is not valid, or that the recipient will not check his/her email messages for some time (e.g., “out of office until January 4”). The email system 10 will be described in more detail below, also in conjunction with FIGS. 1-6.

As can be seen from FIG. 1, the email system 10 includes an email server system 11 and a number of client systems 13 through 13n connected to the email server system 11 via an interconnect network 12. Each of the client systems 13-13n includes an email client application (i.e., 20 through 20n). The email applications 20-20n can also be referred to as client applications or simply clients.

Each of the client systems 13-13n can be a personal computer system or a non-traditional-computer digital device, such as a personal digital assistant, a pager, a cellular phone. Each of the client systems 13-13n also runs one of the email applications 20-20n. Each of the client systems 13-13n is connected to the email server system 11 via an interconnect network 12. The network 12 can be any kind of known network, such as Ethernet, ISDN (Integrated Services Digital Network), T-1 or T-3 link, FDDI (Fiber Distributed Data Network), cable or wireless LMDS network, or telephone line network.

The server 11 forwards messages among the applications 20-20n based on email addresses specified in the messages. The email server system 11 and the email applications 20-20n communicate with each other following a client-server model and rely on the Transmission Control Protocol (TCP) for reliable delivery of information between the server system 11 and the email applications 20-20n. Each application assumes a unique email address when communicating with the server 11. The email applications 20-20n are employed mainly to allow their users to send and/or receive email messages via the email server system 11.

However, each of the email applications 20-20n may sometimes operate with different email addresses, but at different times. This means that when a user of a particular email address logs into the email system 10 through one of the email applications 20-20n, that email application assumes the email address of the logged-in user. The email application then communicates with the email server system 11 to receive all email messages sent to that particular email address. The user can also send email messages to other email addresses via the email application.

The email server system 11 is implemented, for example, by email server software running on a computer system. The computer system can be a server computer, a workstation computer, a mainframe computer, or a super-computer. The computer system may also be a number of computers connected together via a network. The main functions of the email server system 11 include managing email addresses, receiving email messages, delivering queued email messages to client applications, and forwarding email messages to their appropriate destinations.

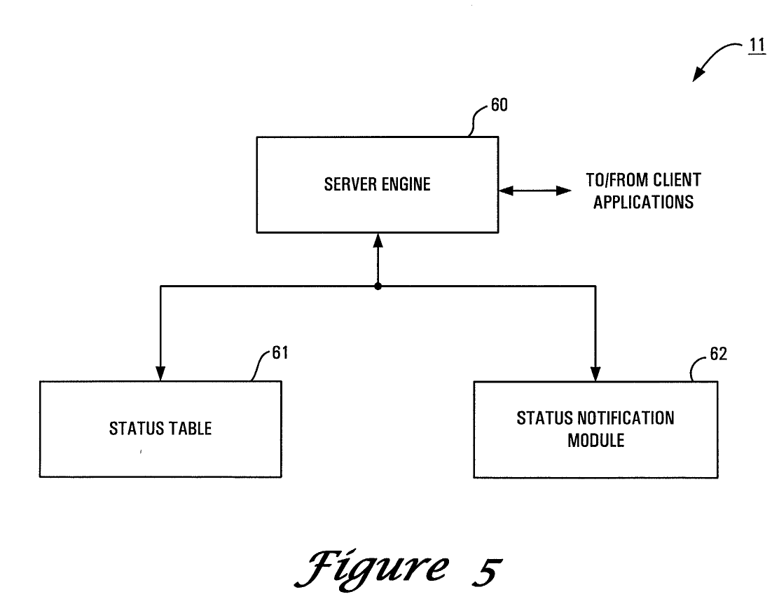

In addition and in accordance with one embodiment of the present invention, the email server system 11 also allows users of the email applications 20-20n to check status of an email address before sending any message to that email address. The structure of the email server system 11 will be described in more detail below, also in conjunction with FIG. 5.

In FIG. 5, the email server system 11 includes a server engine 60 that performs the main functions of the email server system 11. As described above, the main functions of the email server system 11 include managing email addresses, receiving email messages, and forwarding email messages to their appropriate destinations. The server engine 60 may be implemented using known technology. For example, the server engine 60 can be implemented by Microsoft Exchange® email server software manufactured and sold by Microsoft Corporation of Redmond, Wash. The server engine 60 will thus not be described in more detail below.

In accordance with one embodiment of the present invention, the email server system 11 also includes a status table 61, and a status notification module 62. These modules 61-62 are connected to each other and to the server engine 60. These two modules 61-62 are employed to allow the email server system 11 to record and notify the status of any of the email addresses registered in and managed by the server system 11, thus allowing a user of the email system 10 (FIG. 1) to check status of an email address through any one of the email applications 20-20n before sending email messages to that email address.

The status table 61 is employed to record the status of every email address registered in and managed by the email server system 11. As described above, the status of an email address can be “normal”, “out-of-office”, or “invalid” (i.e., the email address is no longer valid). The “out-of-office” status means that the user of the email address is on vacation, on business trip, or extended leave. In this case, the user will not timely read email messages sent to that email address. The “out-of-office” status may also have associated information about when the user will be returning. In this case, the status may have an attached text message with a date field that specifies the return date of the user.

The “invalid” status means that email address is no longer valid in the server system 11. The “invalid” status may also have associated information is about a potential forwarding address or other information about the user.

In one embodiment, the status table 61 contains an entry for each email address registered and managed by the email server system 11. In this case, the table 61 contains an entry for an email address even if the status of that email address is “normal”. In another embodiment, the status table 61 only contains an entry for each of the email addresses that has the “out-of-office” or “invalid” status with a forwarding address.

The status table 61 is basically a lookup table and is indexed by the email addresses. This means that status information of an email address can be recorded in and retrieved from the status table 61 when the status table 61 is accessed with the corresponding email address.

The status notification module 62 is employed to record the status information of any of the email addresses managed by the server system 11 in the status table 61. This is done when the email server system 11 receives a “status change notification” message from one of the email applications 20-20n (FIG. 1). The message indicates which email address has the status change and, if any, the attached text message. For example, if the status change is from “normal” to “out-of-office”, the attached text message may indicate when the user of that email address will be back and how to contact them in an emergency.

In addition, the status notification module 62, when requested, also retrieves the status information of a particular email address from the status table 61. This is triggered when the status notification module 62 receives a “status check” message from one of the email applications 20-20n (FIG. 1) that is about to send a message to that particular email address.

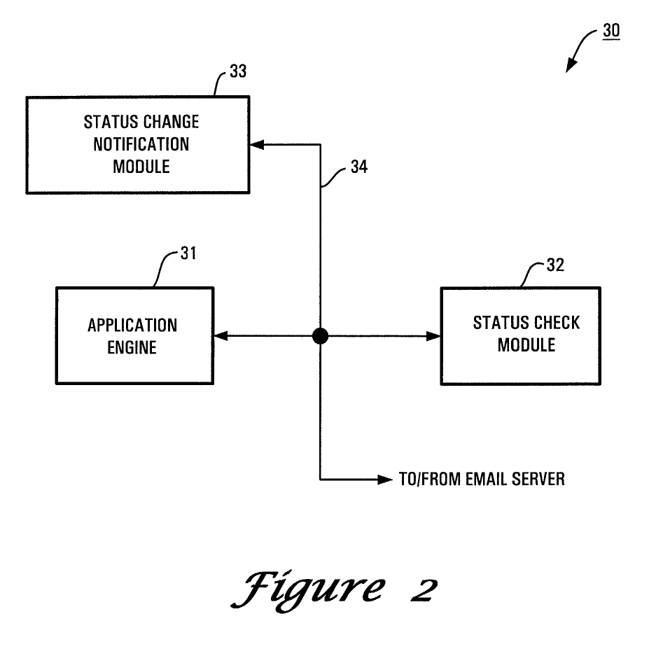

Referring back to FIG. 1, in accordance with one embodiment of the present invention, each of the email applications 20-20n is equipped with a function that, when operated in conjunction with the email server system 11, allows the status of the email addresses of the email system 10 to be checked before an email message is sent to that email address. This means that the user does not need to spend time and effort on an email message, only to find out later that the email message cannot be read by the intended recipient at all (i.e., recipient's email address is invalid) or will not be timely read by the intended recipient (i.e., recipient's email address is in the “out-of-office” status) after the message is sent. The structure of each of the email applications 20-20n will be described in more detail below, also in conjunction with FIG. 2.

FIG. 2 shows the structure of an email application 30, which can be any one of the email applications 20-20n of FIG. 1. In FIG. 2, the email application 30 includes an application engine 31. The application engine 31 performs the main functions of the email application 30, which include interacting with the email server system 11 to send email messages to and receive email messages from other email applications of the email system 10 (FIG. 1). For example, the application engine 31 interacts with the user of the application to enter the text of an email message and to specify the email address of the recipient application. The function of sending a new message can be done by opening a dialog box for the user so that the user can enter the text message and specify the email address of the intended recipient. The application engine 31 may be implemented using known technology. For example, the application engine 31 can be implemented by the Microsoft Outlook® email client application software manufactured and sold by Microsoft Corporation of Redmond, Wash. Another example can be the Netscape Communicator® software manufactured and made available by AOL-Time Warner, Inc. of New York, N.Y. As described above, the Netscape Communicator® software is a comprehensive set of components that integrates browsing, email, and chat functions together to allow users to easily communicate, share, and access information.

In accordance with one embodiment of the present invention, the email application 30 also includes a status check module 32 and a status change notification module 33. The modules 31-33 are operatively connected together. The status change notification module 33 is employed to allow the email application 30 to send status change notification messages to the server system 11 (FIG. 1) whenever there is a status change to the email address of the application 30. This means that if the status of the email address of the email application is changed from one status to another (e.g., from “normal” to “out-of-office” or “invalid”, or from “out-of-office” to “normal” or invalid”) and the user of the email application wants the server system 11 of FIG. 1 to know about the status change, the status change notification 5 module 33 sends a status change message to the server system 11 of FIG. 1 such that the status change can be recorded or registered in the status table 61 (FIG. 5) of the server system 11 (FIG. 1). The status change notification module 33 can receive the status change notification through different user interfaces of the application 30. For example, the status change from “normal” to “invalid” is done from an “invalid address notification” GUI (Graphical User Interface). The status change from “normal” to “out-of-office” is done from a “vacation notification” GUI.

The status change notification module 33 can be invoked by the user of the application 30 through the application engine 31. For example, if the application engine 31 is implemented by the Microsoft Outlook®, then the status change notification module 33 can be invoked when the user invokes the “Out-of-Office Assistant” function under the pull-down menu item “Tools”. Once the user has completed the notification message, the status change notification module 33 causes the application engine 31 to send the status notification message to the server system 11 (FIG. 1).

The status check module 32 is employed to check the status of an email address of a to-be-sent email message before the message is sent to that email address. This status check is performed automatically once the email address is “resolved” (i.e., adequately specified by the user who is composing the message). This means that the process is transparent to the user. In other words, the status check module 32 does the status check by automatically sending a query message to the server system 11 (FIG. 1) as soon as the email address of the recipient application is resolved. The email address can be resolved through the access of the local or corporate address directory in the email client application when the user only specifies a name or a portion (not the entire email address) of the email address. For example, when the user specifies “John Doe”, the application engine 31 or the status check module 32 uses that name to access the local email address book to resolve that name to the corresponding email address (e.g., John_Doe@xyz.com).

In one embodiment, the query message is sent in a remote procedure call. In other embodiments, the query message is sent through other known means.

When the status check module 32 receives the status information from the email server system 11, the status check module 32 causes the application engine 31 to notify the user of the status of the email address of the intended recipient, potentially only if the status is not “normal”.

In one embodiment, the notification caused by the status check module 32 is an automatically opened (i.e., pop-up) email dialog box that contains the message about the status of the email address of the recipient application. In another embodiment, the notification is a voice notification. This means that the notification message is played to the user of the sender application by an audio means. In yet another embodiment, the notification can be in the form of a visual icon (e.g., a red flag or sign) next to the email address.

Referring to FIGS. 1-2 and 5, the operation of the email system 10 in accordance with one embodiment of the present invention is described.

When an email address at one of the client applications 20-20n (i.e., recipient application) has a status change in message receiving and handling (e.g., from “normal” to “out-of-office” or “invalid”, or from “out-of-office” to “normal” or “invalid”), that change is communicated from the recipient application to the email server system 11. This is done by the status notification module 33 of the recipient application. The status change message is recorded in the status table 61 of the email server system 11. This is done by the status notification module 62 of the server system 11.

When the user of another one of the email applications 20-20n (i.e., sender application) wants to send a message to the recipient application and has specified the email address of the recipient application, the sender application queries the status table 61 in the server system 11 for the current status of the recipient application by sending an inquiry to the status table 61 with the email address of the recipient application. This is done by the status check module 32 of the sender application, employing, for example, a remote procedure call.

When the status notification module 62 of the server system 11 receives the request, it accesses the status table 61 for the status information of that email address. The status notification module 62 then sends the status information to the sender application such that the status of the recipient application is determined before a message is sent to the recipient application.

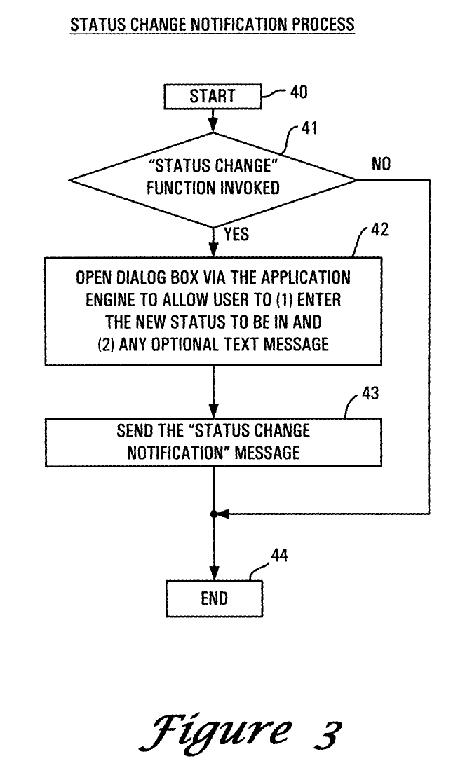

FIG. 3 shows the operational process of the status change notification module 33 of FIG. 2. As can be seen from FIG. 3, the process starts at the step 40. At the step 41, the status change notification module 33 determines whether the “status change” function of the application 30 (FIG. 2) is invoked by its user. If not, the process ends at the step 44. If the answer is yes, then the step 42 is performed, at which the status notification module 33 causes the application engine 31 (FIG. 2) to open the dialog box. This allows the user to enter (1) the new state/status to be into (e.g., “out-of-office” or “normal”), and (2) optional text message (e.g., “I will be out of office until December 12”).

At the step 43, the notification module 33 sends the “status change notification” message (along with any text message attached) to the email server system 11 (FIG. 1) such that the status change can be recorded in the status table 61 (FIG. 5) of the email server system 11 by the status notification module 62 (FIG. 5) of the email server system 11.

As described above, the status change can be from “normal” to “out-of-office” or “invalid”. The status change can also be from “out-of-office” to “normal” (e.g., after returning to the office) or “invalid”. It can also be from “invalid” to “normal” or “out-of-office”. The process then ends that the step 44.

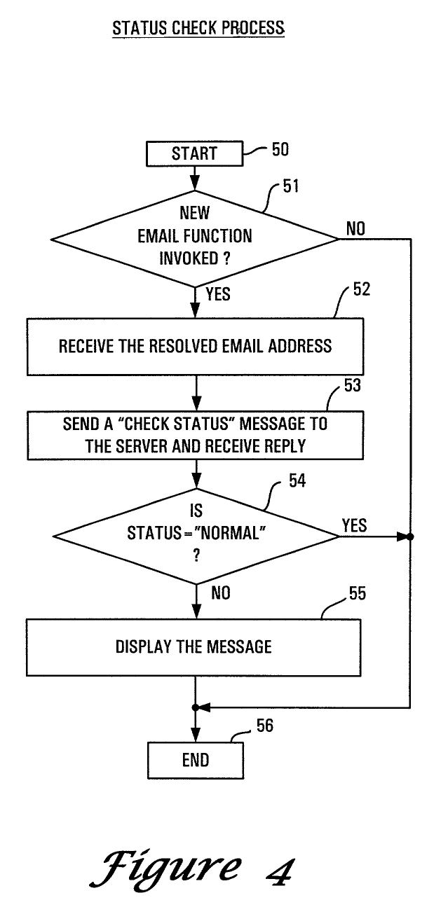

FIG. 4 shows the operational process of the status check module 32 of FIG. 2. As can be seen from FIG. 4, the process starts at the step 50. At the step 51, the status check module 32 determines whether the user of the application 30 of FIG. 2 has invoked the “compose new email” function (i.e., the user wants to compose and send a new email message). If not, the step 56 is the next step. Otherwise, the step 52 is performed, at which the status check module 32 receives the resolved email address. The resolved email address can be generated, for example, by (1) displaying an entry box, (2) waiting for the user to specify the email address of the recipient, or in the alternatively, the name of the email address and the status check module 32 will resolve that into the proper email address corresponding to that name by checking local and/or corporate directories.

The status check module 32, at the step 53, causes a “check status” message to be sent to the server system 11 (FIG. 1), and receives a reply from the server system 11. As described above, this can be implemented using a remote procedure call.

At the step 54, the status check module 32 determines whether the status is in the “normal” status. If the answer is yes, then the step 56 is the next step. If the answer is no, then the step 55 is performed, at which the status check module 32 causes the reply message notifying the status of the email address to be displayed.

As described above, the message can be displayed (or rendered) in a number of ways. For example, the message can be displayed by an automatically opened (i.e., pop-up) email dialog box that contains the message about the status of the email address of the recipient application. In another embodiment, the notification message is played by audio means. In yet another embodiment, the status notification message can be in the form of a visual icon (e.g., a red flag or sign) next to the email address. The process then ends at the step 56.

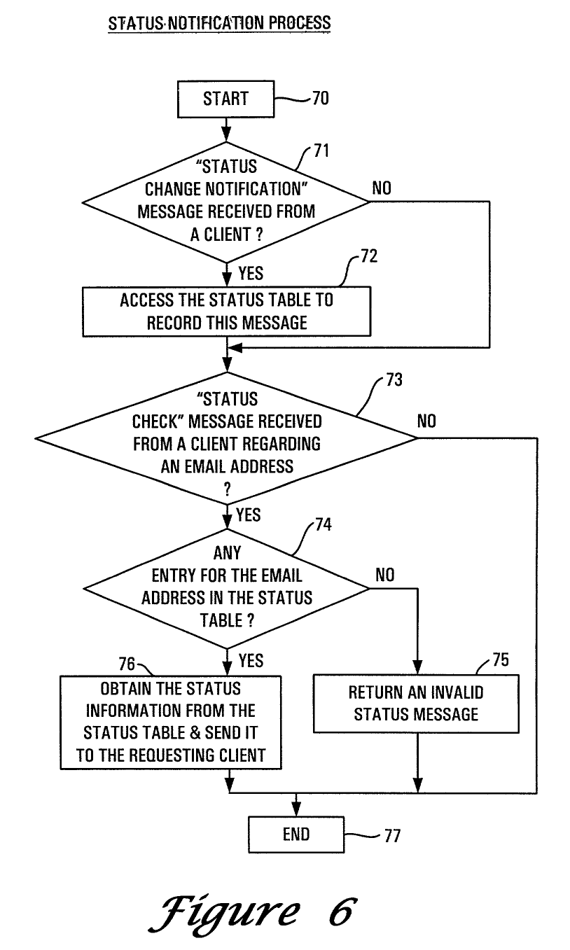

FIG. 6 shows the operational process of the status notification module 62. Referring to FIG. 6, the process starts at the step 70. At the step 71, the status notification module 62 of FIG. 5 determines whether a “status change notification” message is received from one of the email applications 20-20n (FIG. 1). As described above, each of the email applications 20-20n can also be referred to as a client application or simply a client. If the answer is yes at the step 71, then the step 72 is performed. Otherwise, the step 72 is skipped.

At the step 72, the status notification module 62 accesses the status table 61 (FIG. 5) to record the status change message and any attached text message. As described above, the status table 61 is indexed in accordance with the email addresses. At the step 73, the status notification module 62 determines whether a “status check” message is received from one of the email applications 20-20n. If the answer is yes, then the step 74 is performed. Otherwise, the process moves to the step 77.

At the step 74, the status notification module 62 determines whether an entry exists in the status table for this particular email address. If the answer is yes, then the step 76 is performed. If the answer is no, then the step 75 is performed.

At the step 75, the status notification module 62 returns an invalid status message. The process then ends at the step 77.

At the step 76, the status notification module 62 obtains the status information from the status table and sends the status information to the requesting client application. The process then ends at the step 77.

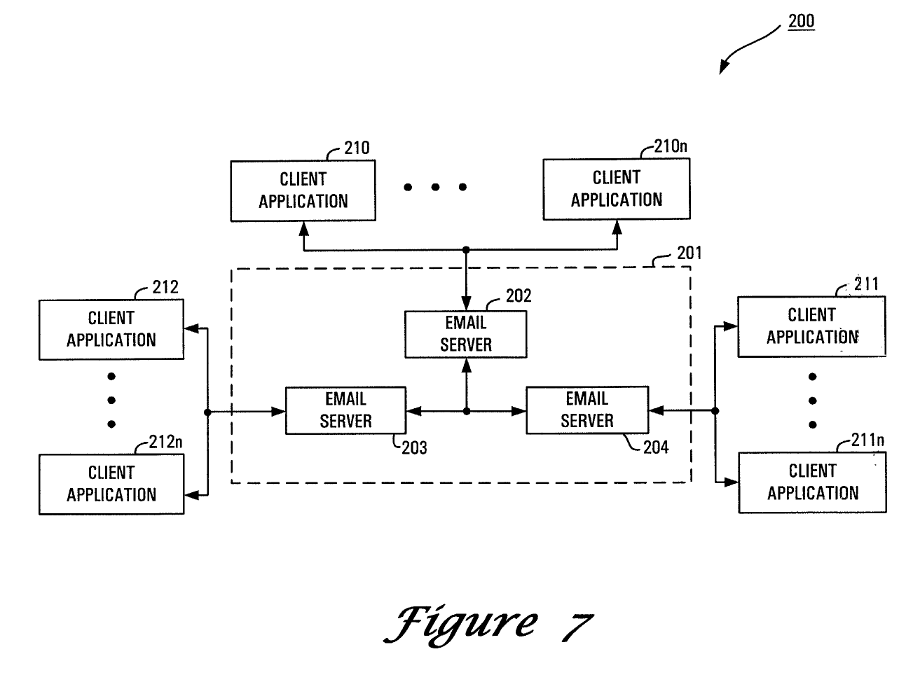

FIG. 7 shows another email system 200 that also implements one embodiment of the present invention. Like the email system 10 of FIG. 1, the email system 200 of FIG. 7 also allows a user of the system to check status of an email address before sending email messages to that email address. The only difference is that the email system 200 of FIG. 7 includes an email server system 201 that includes multiple email servers (i.e., email servers 202 through 204) operationally connected together. Alternatively, they are not connected together, but are such connected that they can exchange messages.

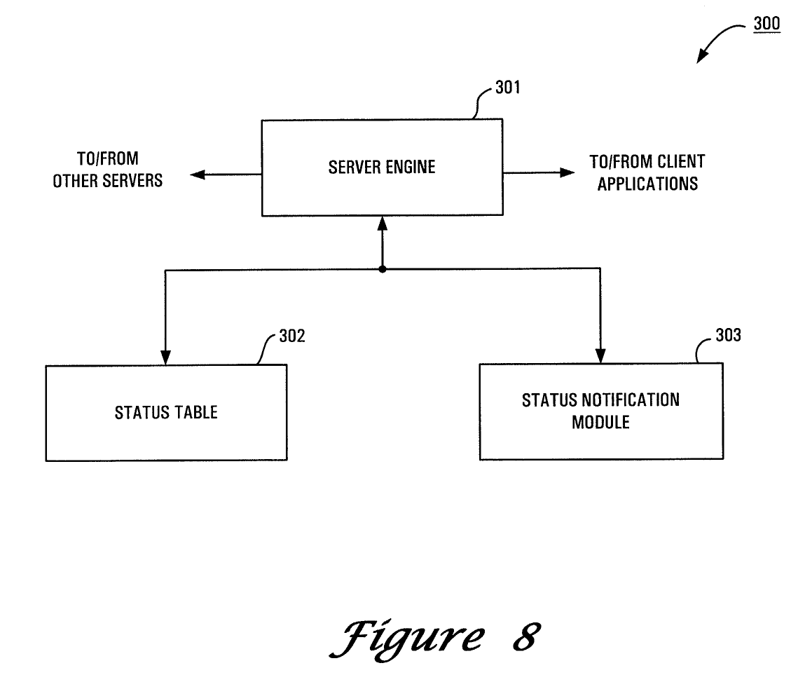

As can be seen from FIG. 7, each of the email servers 202-204 is also operationally connected to a number of email client applications. For example, the email server 202 is connected to a number of email client applications 210-210n while the email server 203 is connected to a number of email client applications 212-212n. This means that each of the email servers 202-204 only manages some of the email addresses of the email system 200. When one email client application (e.g., the application 212) sends an email message to another email application connected to another email server (e.g., the application 211), the email server 203 forwards the email message to the email server 204, which in turn forwards the message to the appropriate email application, as is common in practice. Each of the email servers 202-204 has the same structure, which is shown in FIG. 8.

As can be seen from FIG. 8, the email server 300 can be any one of the email servers 202-204 of FIG. 7. As can be seen from FIG. 8, the email server 300 includes a server engine 301, a status table 302, and a status notification module 303. The server engine 301 performs the same function as the server engine 60 of the email server system 11 of FIG. 5. The status table 302 performs the same function as the status table 61 of FIG. 5. Thus, these two modules will not be described in more detail below.

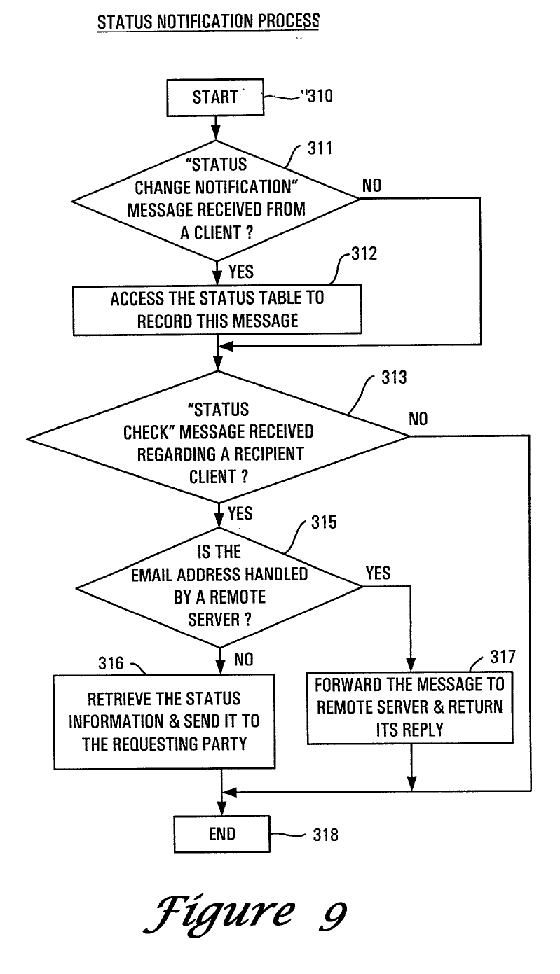

The status notification module 303 of FIG. 8 performs substantially the same function as the status notification module 62 of FIG. 5, except that the status notification module 303 of FIG. 8 includes additional steps. They include forwarding the status check request of an email address to other email servers if the email server 300 does not contain and manage that email address, and receiving results from other email servers. FIG. 9 shows the operational process of the status notification module 303, which will be described in more detail below.

As can be seen from FIG. 9, the process of the status notification module 303 of FIG. 8 starts at the step 310. The steps 311 and 312 are for recording status change of an email address. The steps 313 and 315-317 are for the status check function of the status notification module 303 of FIG. 8. These will be described in more detail below.

In FIG. 9, the status notification module 303 of FIG. 8 determines whether a “status change notification” message is received from one of the email applications connected to the email server 300 (FIG. 8) at the step 311. If the answer is yes at the step 311, then the step 312 is performed. Otherwise, the step 312 is skipped.

At the step 312, the status notification module 303 accesses the status table 302 (FIG. 8) to record the status change message and any attached text message. At the step 313, the status notification module 303 determines whether a “status check” message is received from one of its email client applications. If the answer is yes, then the step 314 is performed. Otherwise, the process ends at the step 318.

At the step 315, the status notification module 303 determines whether this email address is handled by a remote email server. This means that the status notification module 303 of FIG. 8 determines whether that email address is registered in and managed by the server 300. If the answer is yes, then the step 317 is performed. If the answer is no, then the step 316 is performed.

At the step 316, the status notification module 303 obtains the status information from the status table 302 (FIG. 8) using the email address and sends the status information to the requesting client application. The process then ends at the step 318.

At the step 317, the status notification module 303 forwards the status check message to the remote email server, and waits for the return message from the remote email server. If, at the step 317, the returned message from the remote email server indicates that a “hit” (i.e., the remote server contains an entry in its status table for the email address), the status notification module 303 then sends the status information to the requesting email application. If not, an invalid message will be returned to the server 300, which will be sent to the requesting email application. The process then ends at the step 318.

In the foregoing specification, the invention has been described with reference to specific embodiments thereof. It will, however, be evident to those skilled in the art that various modifications and changes may be made thereto without departing from the broader spirit and scope of the invention. The specification and drawings are, accordingly, to be regarded in an illustrative rather than a restrictive sense.

What is claimed is:

1. In an email system having an email server coupled to a plurality of email applications, each having an email address, a method of determining status of a recipient email address, comprising
maintaining status of the recipient email address in a status table, wherein the table is searchable using an email address;
sending an inquiry from a sender application to the table with the recipient email address, when the sender application has resolved the recipient email address to send a message to the recipient email address, to determine the status of the recipient email address before the message is sent to the recipient email address.

2. The method of claim 1, wherein the table is located in the server and the status indicates if (1) the email address of the recipient email address is not valid or no longer valid, (2) the recipient email address is set in an auto-reply mode, or (3) the auto-reply mode for the recipient email address is not set.

3. The method of claim 1, wherein the step of recording status of the recipient email address further comprises the steps of
notifying the server of the status of the recipient email address from a recipient application that assumes the recipient email address when the recipient email address changes its status in message receiving and handling;
recording the new status of the recipient email address in the table.

4. The method of claim 1, wherein the step of sending an inquiry further comprises the steps of
determining in the sender application if the recipient email address has been specified;
if the recipient email address has been specified in the sender application, sending the inquiry from the sender application to the server with the recipient email address;
searching the table with the recipient email address for the status information of the recipient email address;
returning the status of the recipient email address to the sender application from the server.

5. The method of claim 4, wherein the step of sending the inquiry is performed by a remote procedural call.

6. In an email system having a first and a second email server coupled together and a first and a second plurality of email client applications coupled to the first and second servers, respectively, each having an email address, a method of determining status of a recipient email address, comprising
(A) maintaining status of the recipient email address in a status table associated with the first server, wherein the recipient email address is assumed by one of the first plurality of applications, wherein the table stores status information of all of the first plurality of applications and is searchable with an email address;
(B) sending an inquiry from a sender application to the second email server for the status of the recipient email address when a user of the sender application has specified the recipient email address to send a message to the recipient email address, wherein the sender application is one of the second plurality of applications;
(C) forwarding the inquiry from the second server to the first server;
(D) searching the table with the recipient email address for the status of the recipient email address and returning the status to the sender application via the first and second email servers before a message is sent to the recipient email address.

7. The method of claim 6, wherein the status indicates if (1) the email address of the recipient email address is not valid or no longer valid, (2) the recipient email address is set in an auto-reply mode, or (3) the auto-reply mode for the recipient email address is not set.

8. The method of claim 6, wherein the step (C) further comprises the steps of
searching a second status table located in the second server for an entry associated with the recipient email address, wherein the second status table stores status of each of the second plurality of applications;
if the second server is not responsible for the recipient email address, then forwarding the inquiry to the first server.

9. The method of claim 6, wherein the step (A) further comprises the steps of
notifying the first server of the status of the recipient email address from a recipient application that assumes the recipient email address when the recipient email address changes its status in message receiving and handling;
recording the new status of the recipient email address in the table by the first server.

10. The method of claim 6, wherein the step of (B) further comprises the steps of
determining in the sender application if the recipient email address has been specified;
if the recipient email address has been specified in the sender application, sending the inquiry from the sender application to the second server with the recipient email address.

11. The method of claim 10, wherein the step of sending the inquiry is performed by a remote procedural call.

12. In an email system having a sender and a recipient email client application and an email server coupled to the sender and recipient applications, a system of determining status of a recipient email address associated with the recipient application, comprising:
a status table in the server that stores the status of the recipient email address, wherein the table is searchable by an email address;
a status notification module in the server that causes the status of the recipient email address be stored in the status table;
a status check module in the sender application that sends an inquiry with the recipient email address to the status notification module when the recipient email address is determined in the sender application, wherein the status notification module accesses the status table with the recipient email address to obtain and return the status of the recipient email address to the sender application before the sender application sends any message to the recipient email address.

13. The system of claim 12, wherein the status indicates if (1) the email address of the recipient email address is not valid or no longer valid, (2) the recipient email address is set in an auto-reply mode, or (3) the auto-reply mode for the recipient email address is not set.

14. The system of claim 12, wherein the status notification module receives the status of the recipient email address when the recipient email address changes its status in message receiving and handling.

15. The system of claim 12, wherein the status check module sends the inquiry using a remote procedural call.

16. The system of claim 12, wherein the status check module sends the inquiry by
determining if the recipient email address has been specified;
if the recipient email address has been specified, sending the inquiry to the server with the recipient email address.

17. In an email system having a sender email client application coupled to a sender email server and a recipient email client application coupled to a recipient email server, a system of determining status of a recipient email address assumed by the recipient application, comprising:
a status table in the recipient server that stores the status of the recipient email address, wherein the table is searchable by an email address and the sender and recipient servers are coupled together;
a first status notification module in the recipient server that stores the status of the recipient email address in the status table;
a second status notification module in the sender server that forwards inquiries of the status of the recipient email address to the recipient server;
a status check module in the sender application that sends an inquiry with the recipient email address to the first status notification module via the second status notification module in the sender application when the recipient email address is determined in the sender application, wherein the first status notification module accesses the status table with the recipient email address to obtain and return the status of the recipient email address to the sender application before the sender application sends any message to the recipient email address.

18. The system of claim 17, wherein the status indicates if (1) the email address of the recipient email address is not valid or no longer valid, (2) the recipient email address is set in an auto-reply mode, or (3) the auto-reply mode for the recipient email address is not set.

19. The system of claim 17, wherein the second status notification module searches a second status table located in the sender application for an entry associated with the recipient email address, wherein the second status notification module forwards the inquiry to the first status notification module in the recipient server if there is no entry in the second status table that is associated with the recipient email address.

20. The system of claim 17, wherein the first status notification module receives the status of the recipient email address when the recipient email address changes its status in message receiving and handling.

21. The system of claim 17, wherein the status check module sends the inquiry to the sender server using a remote procedural call when the recipient email address has been specified in the sender application.
